(19) United States
(12) Patent Application Publication
(10) Pub. No.: US 2022/0332566 A1
(43) Pub. Date: Oct. 20, 2022

(54) POSTURAL SYSTEM FOR EQUESTRIAN REHABILITATION

(71) Applicant: PRO MEDICARE S.R.L., MESAGNE (BR) (IT)

(72) Inventors: Rosaria Eugenia CAFORIO, MESAGNE (BR) (IT); Roberta GIOBELLINA, MESAGNE (BR) (IT); Chiara LUZZOLI, MESAGNE (BR) (IT)

(21) Appl. No.: 17/760,637

(22) PCT Filed: Sep. 16, 2020
(86) PCT No.: PCT/IB2020/058612

§ 371 Date: Mar. 15, 2022

(30) Foreign Application Priority Data
Oct. 4, 2019 (IT) 102019000017999

(51) Int. Cl. B68C 1/20

(52) U.S. Cl. CPC B68C 1/20; B68C 2001/022

(57) ABSTRACT

A postural system for equestrian rehabilitation is provided that ensures correct positioning of the patient and correct passage of stimuli from the horse to the patient, even in the case of patients with severe motor disabilities. The postural system is modular and customizable and allows positioning the patient on the horse both in a sitting position and in a supine or prone position. The postural system comprises a base body and a plurality of shaped or shapeable blocks adapted to be removably connected to the base body and repositioned onto the base body. By selecting each time the number, shape and orientation of the shaped or shapeable blocks, it is possible to take into account the specific morphology of the user and facilitate perfect placement of the body and correct weight distribution.

### TECHNICAL FIELD

The present invention relates to a postural system for equestrian rehabilitation or hippotherapy. More particularly, the present invention relates to a postural system for equestrian rehabilitation which is modular, customazible and suitable for users suffering from motor disabilities.

### Background Art

Equestrian rehabilitation or hippotherapy is a habilitative or rehabilitative approach that makes use of the stimuli produced by the horse's walking for therapeutic purposes. In fact, the horse at walk makes a rhythmic, constant and three-dimensional movement that allows the patient to experience, at pelvic level, a pattern of movements very similar to the physiological synkinesis of walking.

It is now widely recognized in the literature that hippotherapy can act on the patient, increasing the capacity of trunk postural control, symmetrization, balance, lower limb tone regulation, gross motor skills and coordination, with consequent improvements in life quality.

In addition to the purely physical benefits, the horse's movement helps to promote emotional wellbeing, language and sensory integration.

It is a pleasant rehabilitation activity, perceived by the user almost as a game and therefore particularly suitable for users in the paediatric age group.

In order to make hippotherapy available also to users with severe motor disabilities—especially users without or with very little trunk control—it is necessary to offer the therapist the availability of a postural support that guarantees the passage of stimuli produced by the horse to the patient's ischia, if the patient is in a sitting position, or to his/her back, shoulders and upper limbs, if the patient is in a supine position, or to his/her abdomen, shoulders and upper limbs, if the patient is in a prone position.

The currently available saddles and postural systems for hippotherapy are unable to provide postural support with the aforesaid guarantees.

Furthermore, the currently available saddles and postural systems are unable to guarantee the correct positioning and balance of users with severe motor disabilities without continuous intervention by the therapist, which disturb both the user and the horse and frustrate the beneficial effects of the therapy.

For this reason, most of the literature on equestrian rehabilitation has so far focused almost exclusively on applications to patients with mild motor disabilities and sufficient trunk control, such as autistic patients.

By way of example, document NL 8901537 describes a saddle for disabled patients that allows the patient to be placed on the horse in a sitting position only, but does not allow the patient to be placed on the horse in a supine or prone position.

There is therefore a need, in the field of equestrian rehabilitation, for postural systems that make it possible to extend the user base to include patients with severe motor disabilities and with very little or no body control.

A main object of the invention is therefore to meet this need, by providing a postural system ensuring correct positioning of the patient and correct passage of stimuli from the horse to the patient, even in the case of patients with severe motor disabilities.

Another object of the invention is to provide a postural system which can be adapted to support posture by means of thrusts or grips created “ad hoc” according to the specific morphology of the patient, for example in the presence of strong asymmetries.

Another object of the present invention is to provide a postural system that can be easily modified, with respect to its initial set-up, according to the specific needs of the individual user and his/her evolution over time.

A further object of the present invention is to provide a postural system that is well tolerated and comfortable for both the horse and the patient and that, in particular, has no hooks, buckles or seams that could be annoying to the horse or the patient.

These and other objects are achieved by a postural system as claimed in the appended claims.

### SUMMARY OF INVENTION

The invention has as its object a modular, customizable postural system adapted to assist the therapist in equestrian rehabilitation activities, especially in patients in the paediatric age group suffering from severe motor disabilities.

The postural system according to the invention is designed to assist the therapist in the equestrian rehabilitation activities both when the patient is in a sitting position on the horse and when he/she is in a supine or prone position on the horse.

According to the invention, the postural system comprises a base body, which in turn comprises a lower element and an upper element, and a plurality of shaped or shapeable blocks adapted to be be removably connected to said base body and repositioned onto said base body.

To this end, the lower element and/or the upper element of said base body are provided, on their upper surface, with first connecting means, and said blocks are provided, on their lower surface, with second connecting means, said first and second connecting means cooperating with each other in order to establish a removable connection between said base body and said blocks.

By way of non-limiting example, said first and second connecting means could be made in the form of male and female hook-and-loop strips, such as, for example, Velcro™ strips.

In a possible embodiment of the invention, the lower element and upper element of the base body are made as a single piece.

However, in a preferred embodiment of the invention, the lower element and the upper element of the base body are made as two separate elements that can be coupled to each other.

Advantageously, in this way, the lower element can be made and shaped so that it can adapt to the horse's morphology and absorb its movements and possible jumps, while the upper element can be made and shaped so that it can fittingly adapt to the patient's morphology.

As a result, the same horse can be used for equestrian rehabilitation of patients with very different morphologies by simply coupling to the same lower element upper elements that are different each time and suitable for the general morphological traits of the individual patient.

If, on one hand, the lower element of the base body allows a first “gross” adjustment to the patient's morphology, on the other hand the “fine” adjustment to the patient's morphology and needs is achieved with shaped or shapeable blocks.

The shape and size of each block can be selected each time so as to best adapt to the specific morphology of the patient and their position on the base body can be selected, changed, adjusted each time according to the patient's morphology and needs, to the patient's position (sitting, supine, prone) on the horse and also to the specific rehabilitation exercise.

For the patient to be positioned on the horse either in a sitting position, or in a prone or supine position, the shaped or shapeable blocks of the postural system according to the invention preferably comprise:

a group of blocks for the pelvis of a patient, to be used when the patient is in a sitting position and at least one of:
a group of blocks for the patient's trunk and the pelvis, to be used when the patient is in a supine or prone position;
and
a group of blocks for the patient's head, to be used when the patient is in a supine or prone position.

Furthermore, in a non-limiting manner, the shaped or shapeable blocks of the postural system according to the invention, can comprise:
a group of blocks for the patient's knees;
a group of blocks for the patient's groin and thighs;
a group of blocks for supporting the patient's hands.

The postural system according to the invention may further include accessories, such as stirrups for supporting the patient's feet, a gripping handle, and so on.

Advantageously, the postural system according to the invention can be provided in the form of a kit comprising lower and upper elements of the base body with different shapes and sizes, as well as a large number of shaped or shapeable blocks with different shapes and sizes, so that it will be possible to select each time the components having the most suitable shape and size according to the horse's morphology and the patient's morphology and needs, and assemble the selected blocks to said base body.

### BRIEF DESCRIPTION OF DRAWINGS

Further features and advantages of the present invention will become apparent from the ensuing description of a preferred embodiment of the invention, given by way of non-limiting example, with reference to the annexed drawings, in which:

FIG. 1 is a perspective view of the postural system according to the invention, illustrated in a first configuration;

FIG. 2 is a top view of the postural system of FIG. 1;

FIG. 3 is a top view of the postural system of FIGS. 1 and 2, illustrated in a second configuration.

### DESCRIPTION OF EMBODIMENTS

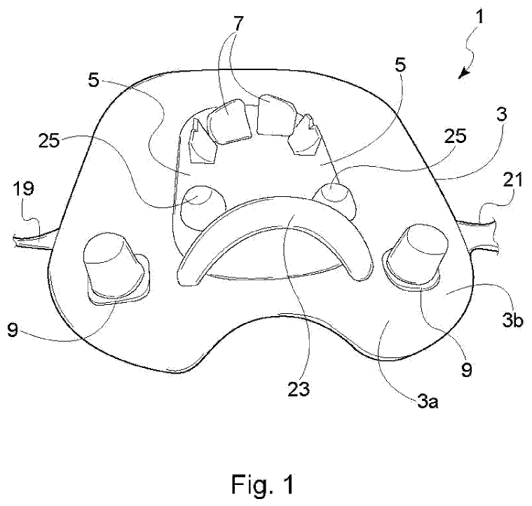

Referring to FIGS. 1-3, there is schematically illustrated a postural system for equestrian rehabilitation, indicated as a whole by reference numeral 1.

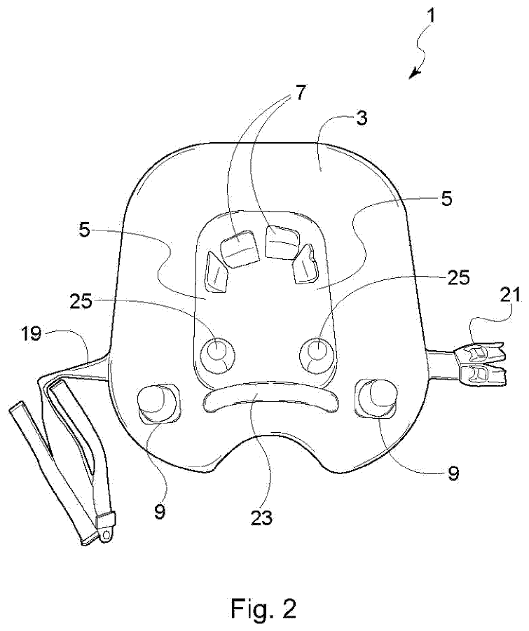

In particular, in FIGS. 1 and 2 the postural system 1 is illustrated in a first configuration, to be used when the patient is in a sitting position on the horse.

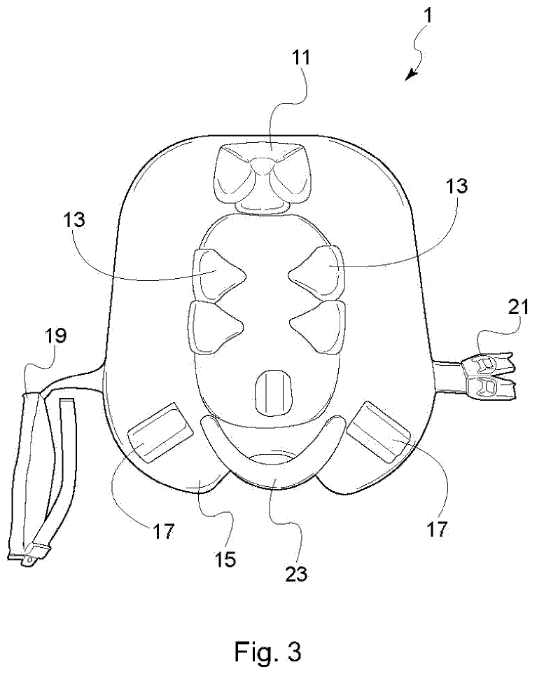

In FIG. 3, the same postural system 1 is illustrated in a second configuration, to be used when the patient is in supine or prone position on the horse.

Referring initially to FIGS. 1 and 2, the postural system 1 comprises a base body 3 having a substantially oval shape, with a front contour to allow placing thereof along the neck of the horse.

The base body 3 consists of a lower element 3a and an upper element 3b.

In a possible embodiment of the invention, said lower and upper elements are made as a single piece (i.e. the base body 3 is made as a single piece).

In the embodiment illustrated in the Figures, instead, the lower element 3a and the upper element 3b are separate elements that can be removably coupled to each other.

Any suitable removable coupling means known to the state of the art can be used for coupling the upper element and the lower element of the base body 3 to each other.

For example, the upper face of the lower element 3a and the lower face of the upper element 3b can be provided with respective coupling means cooperating with each other. In particular, the upper face of the lower element 3a and the lower face of the upper element 3b can be provided with male and female hook-and-look strips, respectively, made, for example, of Velcro™ or similar material.

The lower element 3a of the base body 3 is preferably made of a shapeable material, such as a foam, a gel, a fluid, in order to adapt to the morphology of the horse and absorb its movements and possible jumps. For example, the lower element 3a could be made of a shape memory material, such as a thermosensitive, slow rebound polymer foam.

Said lower element 3a is provided with a lining, which, at the lower face of said lower element 3a, has a coating with anti-slip properties, while at the upper face of said lower element 3a—as anticipated above—it is provided with coupling means for coupling to the upper element 3b.

The lower element 3a of the base body 3 is provided with straps 19 (preferably padded straps, in order not to cause discomfort to the horse) and buckles 21 to secure the base body onto the back of the horse.

Also the upper element 3b of the base body 3 is preferably made of a shapeable material, such as a foam, a gel, a fluid, in order to be able to adapt to the general morphology of the patient. For example, also the upper element 3b could be made of a shape memory material, such as, for instance, a viscoelastic, thermosensitive, slow rebound polymer foam.

Said upper element 3b is provided with a lining which, at the lower face of said upper element 3b—as anticipated above—is provided with coupling means for coupling to the lower element 3a, and, on its upper face, is provided with removable connecting means 5 for removable coupling to one or more shaped or shapeable blocks 7, 9.

Advantageously, by making the base body 3 with two separate elements that can be removably coupled to each other, it is possible to provide a plurality of lower elements 3a and a plurality of upper elements 3b, and subsequently select each time the lower element 3a and the upper element 3b that are most suitable, in terms of shape and size, for the horse's morphology and the patient's morphology and needs, respectively.

In particular, the same horse can be used for equestrian rehabilitation of patients with very different morphologies, by associating to the same lower element 3a upper elements 3b of different shape and size.

Although the upper element 3b can be chosen according to the patient's morphology, it alone cannot provide a customized restraint and support structure for each individual user, unless it is planned to create tailor-made elements (which would, however, lead to costs that are difficult to bear).

Therefore, according to the invention, the postural system further comprises a plurality of shaped or shapeable blocks 7,9 which can be removably connected to and repositioned onto the upper surface of the upper element 3b of the base body 3.

To this end, said shaped or shapeable block 7, 9 are provided, on their lower face, with removable coupling means adapted to cooperate with the removable coupling means provided on the upper face of the upper element 3b of the base body 3.

The blocks 7, 9 can be made with different shapes and sizes and can be positioned in the desired position on the upper surface of the upper element 3b.

As a result, it is possible to create a customized postural system, perfectly adapted to the individual patient's morphology.

Furthermore, it is possible to create a postural system that provides the correct thrusts and grips according to the modalities and aims of the rehabilitation activity.

It will be evident to the person skilled in the art that the postural system according to the invention also makes it possible to modify the overall conformation of the postural system for the same patient, for example in the case of changes over time.

In FIGS. 1 and 2, the postural system 1 is illustrated in a first configuration suitable for a patient in a sitting position.

Correspondingly, a group of shaped or shapeable blocks for positioning the pelvis 7 will be provided.

Said group of shaped or shapeable blocks for positioning the pelvis 7 can include, for example, a pair of blocks (right and left) for the glutei, a pair of blocks (right and left) for the trochanters, and a pair of blocks (right and left), each of which can be positioned and oriented independently of the others.

The system consisting of the shaped or shapeable blocks for positioning the pelvis 7 makes it possible to control and guide the sitting position of the femurs-pelvis-rachis relationship system and to promote extension and alignment of the trunk.

In the configuration illustrated in FIGS. 1 and 2, a further group of shaped or shapeable blocks for adjusting flexion of the knees 9 will also be provided.

Said group of shaped or shapeable blocks for adjusting flexion of the knees 9 can, for example, include a pair or cylindrically shaped guides to guide flexion of the knees and positioning of the legs.

The postural system 1 may further comprise additional accessories, such as, for example, a handle 23 and blocks for the hands 25 for supporting the patient's hands.

Advantageously, also the blocks for the hands 25 can be provided for being removably connectable to the base body 3 and repositioned thereon and to this end they can be provided, on their lower face, with removable connecting means adapted to cooperate with the removable connecting means provided on the upper surface of the upper element 3b of the base body 3.

In addition to the accessories shown in FIGS. 1-2, the postural system according to the invention may further include additional accessories, such as, for example, stirrups for supporting the patient's feet. Said stirrups will include each a strap having, at a first end thereof, removable coupling means adapted to cooperate with the removable coupling means provided on the upper face of the upper element 3b of the base body 3, and, at the second, opposite end, with an element for restraining and supporting the patient's foot.

Said element for restraining and supporting the patient's foot could be a simple loop formed by the strap itself, but it is also possible to provide that also the second end of the strap be equipped with removable coupling means and that an element intended for restraining and supporting the patient's foot (for example, a suitably shaped block) be removably coupled to said second end of said strap.

It will be evident to the person skilled in the art that, thanks to the removable coupling means provided at the first end of the strap, the stirrups can be positioned each time in the desired position on the upper element of the base body.

It will further be evident to the person skilled in the art that the length of the straps will preferably be adjustable, so that it can be adapted to the morphology of the individual patient.

Turning now to FIG. 3, the postural system 1 is illustrated in a second configuration enabling the patient to lie in a supine position of the horse's back.

To this end, the shaped or shapeable blocks 7, 9 have been removed from the base body 3 (which is the same as in the previous Figures) and other shaped or shapeable blocks have been positioned “ad hoc” on the upper face of the upper element 3b of the base body 3.

In particular, in this configuration there is provided a group of shaped or shapeable blocks for positioning the head 11.

Said group of shaped or shapeable blocks for positioning the head 11 can include, for example, a pair of blocks that can be positioned on the right and on the left of the patient's neck; said blocks are shaped so that they define together a cavity arranged to receive and hold the patient's occiput, so as to restrain, align and guide the position of the head.

In this second configuration, there is further provided a group of shaped or shapeable blocks for positioning the trunk 13.

Said group of shaped or shapeable blocks for positioning the trunk 13 can include, for example, one or more pairs (in the illustrated embodiment, two pairs) of blocks having a convex, wrap-up shape to laterally restrain the trunk and pelvic/lumbar segment.

In FIG. 3, there can also be seen a group of shaped or shapeable blocks for the groin 15 (adductor group) to keep the patient's legs apart.

Said group of shaped or shapeable blocks for the groin 15 can include, for example, one or more blocks forming together a parallelepiped shape with rounded corners.

In the configuration of FIG. 3, the postural system further comprises a group of shaped or shapeable blocks for adjusting flexion of the knees 17.

Said group of shaped or shapeable blocks for adjusting flexion of the knees 17 can include, for example, a pair of blocks for guiding flexion of the knees. Each of said blocks can in turn consist of a plurality of layers associated with one another in a removable manner in order to adjust the overall thickness thereof and, consequently, the corresponding degree of flexion.

The blocks of the postural system 1 according to the invention can be shaped blocks, they can be made of a plastic or composite material and they can be pre-shaped and adaptable by means of cutting, material removal or other similar processes. For example, said blocks could be made of polyethylene.

In combination with or in alternative to the above, the blocks of the postural system 1 according to the invention can be shapeable blocks, made, for example, by using gels, fluids, foams, shape memory materials and the like.

In combination with or in alternative to the above, the blocks of the postural system 1 according to the invention can be blocks comprising an envelope in which one or more pockets are provided, wherein each pocket can be filled with materials having different characteristics (especially with respect to stiffness).

It will be evident from what has been said above that the postural system according to the invention makes it possible to achieve the objects set forth above.

Indeed, by providing a kit comprising one or more lower and upper elements for the base body and a plurality of shaped or shapeable blocks with different shapes and sizes for each body segment, it will be possible to choose each time the number, shape, size and orientation of said components in order to take into account the specific morphology of the user and facilitate perfect placement of the body and correct weight distribution, thus allowing making equestrian rehabilitation accessible also to patients with severe motor disabilities and with very little or no body control, and optimizing the beneficial effects of said activity.

It will also be evident that the embodiments described above have been given merely by way of example and that numerous modifications and variations are possible without leaving the scope of protection of the invention, as defined by the appended claims.

For example, in the embodiment illustrated in the Figures, the lower element and the upper element of the base body substantially have the same size when seen in a plan view, whereby the upper element entirely covers the lower element and the shaped or shapeable blocks are all applied to the upper face of the upper element of the base body. However, it will be possible to provide that the upper element of the base body be sized so as to only partially cover the lower element; in this case, some of the shaped or shapeable blocks could be applied to the upper face of the lower element of the base body.

1. A postural system for equestrian rehabilitation,
comprising a base body, wherein the postural system further comprises a plurality of modular blocks, which are removably and repositionably connected to the base body, wherein the base body has an upper surface and a lower surface, wherein each of the modular blocks has an upper surface and a lower surface, wherein the upper surface of the base body is provided with first removable connecting means and the lower surface of each of the modular blocks is provided with second removable connecting means cooperating with the first removable connecting means of the base body, wherein the postural system comprises a group of modular blocks for positioning the pelvis of a patient in a sitting position, and wherein the postural system further comprises at least one of
a group of modular blocks for positioning the head of a patient in a supine or prone position, and
a group of modular blocks for positioning the trunk of a patient in a supine or prone position.

2. The postural system for equestrian rehabilitation according to claim 1, wherein the base body is composed of a lower element and an upper element, the lower element and the upper element being separate elements which can be coupled to each other in a removable manner.

3. The postural system for equestrian rehabilitation according to claim 2, wherein the postural system comprises a plurality of lower elements of the base body having different shapes and sizes.

4. The postural system for equestrian rehabilitation according to claim 2, wherein the lower element has an upper face and a lower face, wherein the upper element has an upper face and a lower face, and wherein the upper face of the lower element and the lower face of the upper element are provided with respective coupling means cooperating with each other.

5. The postural system for equestrian rehabilitation according to claim 2, wherein the lower element has an upper face and a lower face, wherein the upper element has an upper face and a lower face, wherein the upper face of the lower element and/or the upper face of the upper element is/are provided with the first removable coupling means for the removable and repositionable coupling connection of said shaped or shapeable the modular blocks.

6. (canceled)

7. The postural system for equestrian rehabilitation according to claim 1, wherein the postural system further comprises a group of modular blocks for adjusting flexion of the knees of a patient in a sitting position.

8-9. (canceled)

10. The postural system for equestrian rehabilitation according to claim 1, wherein the postural system further comprises a group of modular blocks for the groin of a patient in a supine or prone position.

11. The postural system for equestrian rehabilitation according to claim 1, wherein the postural system further comprises a group of modular blocks for adjusting flexion of the knees of a patient in a supine position.

12. The postural system for equestrian rehabilitation according to claim 1, wherein the postural system further comprises a group of modular blocks for supporting the hands of a patient.

13. The postural system for equestrian rehabilitation according to claim 1, wherein the postural system further comprises a pair of stirrups.

14. The postural system for equestrian rehabilitation according to claim 13, wherein each of the stirrups comprises a strap having a first end and a second, opposite end, wherein each of the stirrups has, at the first end, removable connecting means adapted to cooperate with the first removable coupling connecting means provided on the upper surface of the base body, and wherein each of the stirrups has, at the second, opposite end, an element for restraining and supporting a patient's foot.

15. The postural system for equestrian rehabilitation according to claim 1, wherein the modular blocks are made of a plastic or composite material and are pre-shaped.

16. The postural system for equestrian rehabilitation according to claim 1, wherein the modular blocks are made by using gels, fluids, foams, or shape memory materials.

17. The postural system for equestrian rehabilitation according to claim 1, wherein each of the modular blocks comprises an envelope in which one or more pockets are defined, and wherein each pocket is filled with materials having different characteristics.

18. The postural system for equestrian rehabilitation according to claim 4, wherein the upper face of the lower element and the lower face of the upper element are provided with respective male and female hook-and-loop strips cooperating with each other.

19. The postural system for equestrian rehabilitation according to claim 2, wherein the postural system comprises a plurality of upper elements of the base body having different shapes and sizes.
